(19) United States
(12) Patent Application Publication
(10) Pub. No.: US 2026/0029301 A1
(43) Pub. Date: Jan. 29, 2026

(54) SYSTEMS AND METHODS FOR REAL-TIME ESTIMATION OF WIND ENERGY AND IMPACT ON A VEHICLE

(71) Applicant: FCA US LLC, Auburn Hills, MI (US)

(72) Inventors: Vivek Jairazbhoy, Auburn Hills, MI (US); Stephane Maurel, Poissy (FR); Ludmila Leborgne, Poissy (FR); Antoine Simon, Poissy (FR); Alfredo Wulf, Poissy (FR); Ali Alhakim, Poissy (FR)

(21) Appl. No.: 18/780,895

(22) Filed: Jul. 23, 2024

(51) Int. Cl. G01M 9/06

(52) U.S. Cl. CPC G01M 9/06

(57) ABSTRACT

A wind energy estimation and control system for an automobile includes a memory configured to store data indicative of an aerodynamic characterization of the automobile, generated offline by an external computing system, and control system configured to access the memory and to determine a speed and direction of a wind impacting the automobile, estimate a relative velocity between the automobile and a surrounding airstream based on the data indicative of the automobile's aerodynamic characterization, the wind speed, and the wind direction, estimate an angle of attack of the airstream based on the estimated relative velocity between the automobile and the surrounding airstream, estimate a longitudinal component of an aerodynamic drag force impacting the automobile based on the estimated angle of attack of the airstream, the wind speed, and the wind direction, and generate an output based on the estimated longitudinal component of the aerodynamic drag force impacting the automobile.

### FIELD

The present application generally relates to battery electric vehicles (BEVs) and, more particularly, to real-time estimation of wind energy and its impact on a BEV.

### BACKGROUND

Traditionally, the impact of wind on vehicle (e.g., automobile) energy is either ignored or approximated in an inaccurate manner. This is because internal combustion engines are inherently inefficient and thus the impact of wind in the control of the engine is negligible. This changes, however, for electrified automobiles and, more specifically, battery electric vehicles (BEVs) that do not have an engine. Conventional wind energy estimation methods include the subtraction method (i.e., adding or subtracting a head/tail wind from the automobile's energy) and, more recently, the vector subtraction method, which relates the impact of wind yaw angle on automobile drag. There are also other empirical-based wind energy estimation methods for higher automobile speeds (e.g., 60-75 miles per hour, or mph). These conventional methods are all somewhat inaccurate and are incapable of accurate real-time wind energy estimation. Accordingly, while such conventional wind energy estimation and control techniques do work well for their intended purpose, there exists an opportunity for improvement in the relevant art.

### SUMMARY

According to one example aspect of the invention, a wind energy estimation and control system for an automobile is presented. In one exemplary implementation, the wind energy estimation and control system comprises a memory configured to store data indicative of an aerodynamic characterization of the automobile, the data indicative of the aerodynamic characterization of the automobile having been generated offline by an external computing system, and a control system configured to access the memory and to determine a speed and direction of a wind impacting the automobile, estimate a relative velocity between the automobile and a surrounding airstream based on the data indicative of the aerodynamic characterization, the wind speed, and the wind direction, estimate an angle of attack of the airstream based on the estimated relative velocity between the automobile and the surrounding airstream, estimate a longitudinal component of an aerodynamic drag force impacting the automobile based on the estimated angle of attack of the airstream, the wind speed, and the wind direction, and generate an output based on the estimated longitudinal component of the aerodynamic drag force impacting the automobile.

In some implementations, the control system is further configured to access a trained energy consumption model stored in the memory and use the trained energy consumption model and the estimated longitudinal component of the aerodynamic drag force impacting the automobile to generate an estimated energy consumption of the automobile. In some implementations, the generated output is an estimated range of the automobile.

In some implementations, the aerodynamic characterization of the automobile is a model of an aerodynamic force of the automobile that is proportional to a square of the relative velocity between the automobile and the surrounding airstream acting in the direction of the relative velocity. In some implementations, the control system is configured to estimate the relative velocity (vᵣₑₗ) between the automobile and the surrounding airstream as follows:

$${v}_{r e l} = {v}_{w}^{2} + {f}_{2 θ} {v}_{rel}^{2} cos {θ}_{1} + 2 {v}_{w} {v}_{c a r} cos ( {θ}_{w} )$$

where v_{w} represents the wind speed, v_{car} represents a speed of the automobile, and θ_{w} represents the wind direction.

In some implementations, the control system is further configured to correct the estimated relative velocity vᵣₑₗ based on at least one of (i) elevation differences in data collection versus data utilization, (ii) sheltering by road-side wind barriers, (iii) an effect of the ground surface on the aerodynamic coefficient, and/or (iv) automobile traffic density. In some implementations, the control system is configured to estimate the angle of attack using the following equations:

$${θ}_{1} = arc sin ( \frac{{v}_{w}}{{v}_{rel}} sin {θ}_{w} )$$

$$( {v}_{car} < {v}_{w} ) \to {θ}_{w , crit} = 180 ° - arccos ( \frac{{v}_{car}}{{v}_{w}} )$$

$$( {v}_{car} = {v}_{w} ) \to {θ}_{w , crit} = 180 °$$

$$( {v}_{car} \leq {v}_{w} ) and ( {θ}_{w} < {θ}_{w , crit} ) \to {θ}_{1} = arc sin ( \frac{{v}_{w}}{{v}_{rel}} sin {θ}_{w} )$$

$$( {v}_{car} < {v}_{w} ) and ( {θ}_{w} > {θ}_{w , crit} ) \to {θ}_{1} = 180 ° - arc sin ( \frac{{v}_{w}}{{v}_{rel}} sin {θ}_{w} ) ,$$

where θ₁ represents the angle of attack, ranging from 0° to a critical angle θ_{w,crit}, v_{w} represents the wind speed, θ_{w} represents the wind direction, and v_{car} represents the automobile speed.

In some implementations, the control system is configured to estimate the longitudinal component (F_{rel,longitudinal}) of the aerodynamic drag force (Fᵣₑₗ) impacting the automobile using the following equations:

$${F}_{rel , longitudinal} = {f}_{2 θ} {v}_{rel}^{2} cos {θ}_{1}$$

$${f}_{2 θ , scaled} = \frac{{f}_{2} {v}_{rel}^{2} cos {θ}_{1}}{{v}_{car}^{2}} ,$$

where f_{2θ,scaled} represents a scaled version of a frontal coefficient f₂ from a road load equation:

$${F}_{rel} = {f}_{0} + {f}_{1} * {v}_{car} + {f}_{2 θ , scaled} * {v}_{car}^{2} ,$$

where f₀ and f₁ represent a constant and another coefficient In the road load equation. In some implementations, the automobile is a battery electric vehicle (BEV) that does not include an internal combustion engine. In some implementations, the control system is configured to receive the wind speed and wind direction from a weather application program interface (API).

According to another example aspect of the invention, a wind energy estimation and control method for an automobile is presented. In one exemplary implementation, the wind energy estimation and control method comprises receiving and storing, by a memory and from an external computing system, data indicative of an aerodynamic characterization of the automobile, the data indicative of the aerodynamic characterization of the automobile having been generated offline by the external computing system, determining, by a control system of the automobile that is configured to access the memory, a speed and direction of a wind impacting the automobile, estimating, by the control system, a relative velocity between the automobile and a surrounding airstream based on the data indicative of the aerodynamic characterization, the wind speed, and the wind direction, estimating, by the control system, an angle of attack of the airstream based on the estimated relative velocity between the automobile and the surrounding airstream, estimating, by the control system, a longitudinal component of an aerodynamic drag force impacting the automobile based on the estimated angle of attack of the airstream, the wind speed, and the wind direction, and generating, by the control system, an output based on the estimated longitudinal component of the aerodynamic drag force impacting the automobile.

In some implementations, the wind energy estimation and control method further comprises accessing, by the control system and from the memory, a trained energy consumption model stored in the memory and using, by the control system, the trained energy consumption model and the estimated longitudinal component of the aerodynamic drag force impacting the automobile to generate an estimated energy consumption of the automobile. In some implementations, the generated output is an estimated range of the automobile.

In some implementations, the aerodynamic characterization of the automobile is a model of an aerodynamic force of the automobile that is proportional to a square of the relative velocity between the automobile and the surrounding airstream acting in the direction of the relative velocity. In some implementations, the estimating of the relative velocity (vᵣₑₗ) between the automobile and the surrounding airstream is performed as follows:

$${v}_{rel} = {v}_{w}^{2} + {v}_{car}^{2} + 2 {v}_{w} {v}_{car} cos ( {θ}_{w} )$$

where v_{w} represents the wind speed, v_{car} represents a speed of the automobile, and θ_{w} represents the wind direction.

In some implementations, the wind energy estimation and control method further comprises correcting, by the control system, the estimated relative velocity vᵣₑₗ based on at least one of (i) elevation differences in data collection versus data utilization, (ii) sheltering by road-side wind barriers, (iii) an effect of the ground surface on the aerodynamic coefficient, and/or (iv) automobile traffic density. In some implementations, the estimating of the angle of attack is performed using the following equations:

$${θ}_{1} = arc sin ( \frac{{v}_{w}}{{v}_{rel}} sin {θ}_{w} )$$

$$( {v}_{car} < {v}_{w} ) \to {θ}_{w , crit} = 180 ° - arccos ( \frac{{v}_{car}}{{v}_{w}} )$$

$$( {v}_{car} = {v}_{w} ) \to {θ}_{w , crit} = 180 °$$

$$( {v}_{car} \leq {v}_{w} ) and ( {θ}_{w} < {θ}_{w , crit} ) \to {θ}_{1} = arc sin ( \frac{{v}_{w}}{{v}_{rel}} sin {θ}_{w} )$$

$$( {v}_{car} < {v}_{w} ) and ( {θ}_{w} > {θ}_{w , crit} ) \to {θ}_{1} = 180 ° - arc sin ( \frac{{v}_{w}}{{v}_{rel}} sin {θ}_{w} ) ,$$

where θ₁ represents the angle of attack, ranging from 0° to a critical angle θ_{w,crit}, v_{w} represents the wind speed, θ_{w} represents the wind direction, and v_{car} represents the automobile speed.

In some implementations, the estimating of the longitudinal component (F_{rel,longitudinal}) of the aerodynamic drag force (Fᵣₑₗ) impacting the automobile is performed using the following equations:

$${F}_{rel , longitudinal} = {f}_{2 θ} {v}_{rel}^{2} cos {θ}_{1}$$

$${f}_{2 θ , scaled} = \frac{{f}_{2} {v}_{rel}^{2} cos {θ}_{1}}{{v}_{car}^{2}} ,$$

where f_{2θ,scaled} represents a scaled version of a frontal coefficient f₂ from a road load equation:

$${F}_{rel} = {f}_{0} + {f}_{1} * {v}_{car} + {f}_{2 θ , scaled} * {v}_{car}^{2} ,$$

where f₀ and f₁ represent a constant and another coefficient In the road load equation. In some implementations, the automobile is a BEV that does not include an internal combustion engine. In some implementations, the determining of the wind speed and wind direction comprises receiving, by the control system and from a weather API, the wind speed and wind direction.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a functional block diagram of a battery electric vehicle (BEV) having an example wind energy estimation and control system according to the principles of the present application;

FIG. 2 is a flow diagram of an example wind energy estimation and control method for an automobile (e.g., a BEV) according to the principles of the present application; and

FIGS. 3-4 are plots of example automobile velocity and wind data and the calculation of relative velocity between an automobile and a surrounding airstream according to the principles of the present application.

### DESCRIPTION

As previously discussed, conventional wind energy estimation methods are all somewhat inaccurate and are incapable of accurate real-time wind energy estimation One conventional wind energy estimation method is the subtraction method. In this method, data is correlated to aerodynamic effects on a moving automobile over a range of automobile speeds in the form of a coefficient that multiplies the square of the velocity in a road load equation. The impact of wind energy on automobile energy consumption is usually neglected or, alternatively, is included by subtracting the longitudinal component of the wind speed from the automobile speed. The subtraction method works well with a perfect headwind and reasonably well with a perfect tailwind. In practice, however, wind direction will usually be imperfect (non-coincidental) with the automobile velocity vector, thereby resulting in a flawed or inaccurate estimation. More specifically, the subtraction method approximates the aerodynamic force using the component of wind velocity in the (longitudinal) direction of automobile motion, uses the frontal area/geometry of the automobile to estimate drag even when the wind does not act along the longitudinal direction, and yields an incorrect result when the relative velocity vector aids automobile motion.

Another conventional wind energy estimation is the vector subtraction method. In this method, the impact of wind yaw angle is related to automobile drag. The wind yaw angle often increases the drag coefficient at the commonly observed smaller yaw angles (e.g., −25° to 25°) and is a function of lift and side force. Other effects could also be anticipated, such as air density and scaling the wind speed to compensate for the fact that the wind data may be obtained at any height above the road surface, and that the automobile rarely drives in an open field where it is subject to the full influence of the wind. That is, most often the automobile is at least partially sheltered from the wind by road-side structures, tress, or buildings. The vector subtraction method fails to describe the aerodynamic characterization of the automobile at all feasible wind-to-automobile-velocity resultant vectors and defines drag in terms on the longitudinal component of velocity rather than force, resulting in yaw angle limitations (i.e., the method may not work for larger, less likely yaw angles (e.g., >+/−25°). In addition, a resultant tailwind would yield a retarding drag force rather than an aid in automobile motion.

Yet another conventional wind energy estimation method is a speed-limited empirical-based wind energy estimation method, such as for high automobile speeds (e.g., 60-75 miles per hour, or mph). For example only, empirical data could be collected and represented as a pixel plot of the measured additional power required by an automobile to counter the effects of wind, with a longitudinal and transverse components of wind speed specified on the x and y-axes respectively (e.g., for automobile speeds from ˜62.5 miles per hour, or mph, to ˜75 mph). Such an empirical-based method metho, however, is likely limited to only higher automobile speeds and does not have the resolution to estimate contributions accurately at lower automobile speeds. In other words, this empirical method is not applicable over the entire range of automobile speeds. Further, even if this empirical method were extended to a full range of automobile speeds, it would take a substantial amount of testing to gather the empirical data and then would require substantial storage requirements at the automobile such that the empirical data could be accessed for subsequent real-time (online) wind energy estimation.

Accordingly, improved systems and methods for real-time (online) estimation of wind energy and its impact on a vehicle (e.g., an automobile) using a physics-based model are presented herein. While these techniques are applicable to any automobiles, it will be appreciated that these techniques are particularly applicable to battery electric vehicles (BEVs) that do not have an inefficient internal combustion engine. These techniques estimate wind energy based on automobile speed, wind speed, and wind direction. The wind speed/direction is obtainable directly from meteorological sources or via a third-party weather application program interface (API). Specifically, the techniques extract the automobile's two-dimensional (2D) aerodynamic characteristics as a function of wind speed/direction, identify a direction of a relative velocity vector, and apply an aerodynamic estimation of drag force (rather than wind speed) to a road load equation or other power/consumption model. Potential benefits include more accurate estimation of wind energy (e.g., tail winds that actually aid the automobile motion), which can then be used, for example, for more accurate estimation of automobile energy consumption and thereby improved automobile trip planning/performance and an improved user experience.

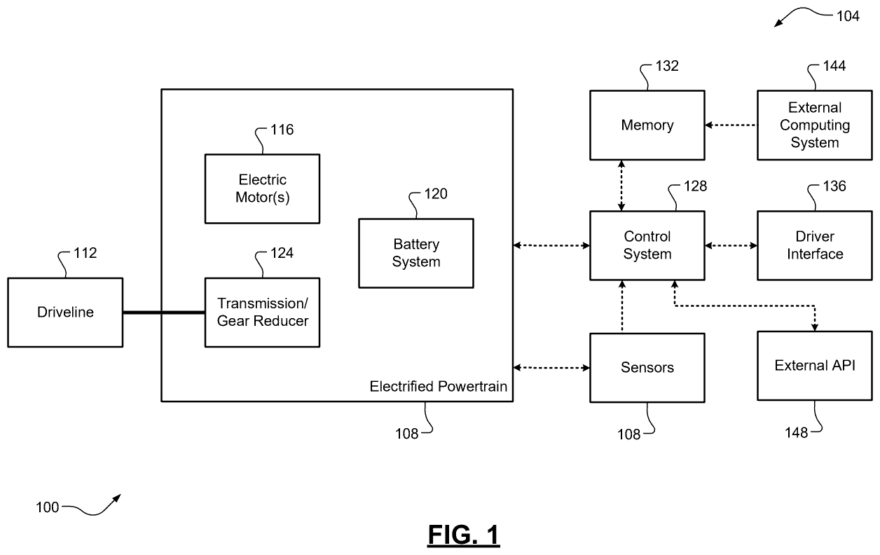

Referring now to FIG. 1, a functional block diagram of a BEV 100 having an example wind energy estimation and control system 104 according to the principles of the present application is illustrated. While a BEV configuration is specifically illustrated and discussed herein, it will be appreciated that the wind energy estimation and control techniques of the present application are applicable to any automobile (e.g., including automobiles having an internal combustion engine), although these techniques are particularly applicable to BEVs for the various reasons described herein. The BEV 100 (also, “automobile 100”) generally comprises an electrified powertrain 108 configured to generate and transfer drive torque to a driveline 112 for propulsion. As shown, the electrified powertrain 108 includes an electric motor 116 (e.g., an electric traction motor) that is powered by electrical energy supplied by a high voltage battery system 120. The electric motor 116 is configured to transfer its generated torque directly, via a gear reducer or a transmission 124 (a multi-speed automatic transmission, a continuously variable transmission, etc.) to the driveline 112 (a differential, axles or half-shafts, wheels, etc.).

While not shown, it will be appreciated that the electrified powertrain 108 could include other energy sources as previously discussed above, such as an internal combustion engine and/or a fuel cell system. These other energy sources could be configured to generate additional mechanical or electrical energy, such as for powering the driveline 112 and/or for recharging the battery system 120. It will also be appreciated that the techniques herein are uniquely applicable to automobiles and not to other types of vehicles (e.g., human-powered bicycles). A control system 128, having an integrated or separate memory 132 (e.g., a non-volatile memory, or NVM), controls operation of the automobile 100. This primarily includes controlling the electrified powertrain 108 to generate a desired amount of drive torque in satisfaction of a driver torque request received via a driver interface 136 (e.g., an accelerator pedal). The control system 128 can perform its control of the electrified powertrain 108 based further on measured operating parameters from a plurality of sensors 140. The plurality of sensors 140 are configured to measure operating parameters such as speeds/accelerations, pressures, temperatures, electrical parameters (voltage, current, etc.), etc.

These measured operating parameters could be real-time (online) inputs for a wind energy estimation model (and, in some cases, a trained automobile energy consumption model) as part of the techniques of the present application. In some implementations, at least some of the operating parameters (wind speed/direction, road grade, etc.) could be provided via an external application programming interface (API) 148 (e.g., a cloud-based server) via wireless (e.g., cellular) or “over-the-air” (OTA) communication. The control system 128 is also configured to model other operating parameters of the automobile 100 based on at least some of these measured parameters. For example, a state of charge (SOC) of the battery system 120 could be modeled based on measured electrical parameters, such as using a Kalman filter type estimation. Other parameters, which will be discussed in greater detail below, could also be modeled or estimated by the control system 128, which is also configured to perform at least a portion of the techniques of the present application. Some aspects of the present application could also be performed by an external calibration or computing system 144, such as the offline development of a portion of the wind energy estimation model (and, in some cases, offline training of an automobile energy consumption model, such as a neural network type model).

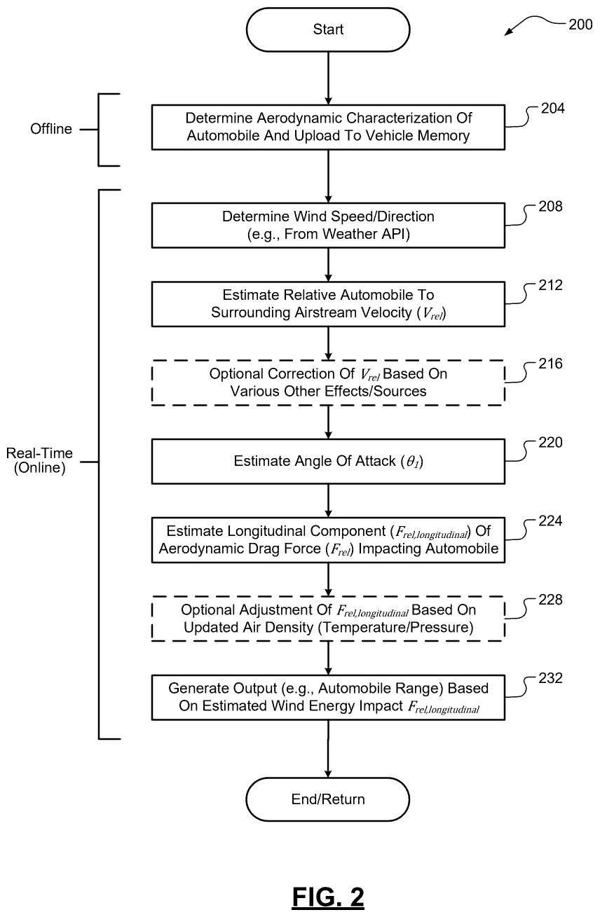

Referring now to FIG. 2 and with continued reference to FIG. 1, a flow diagram of an example wind energy estimation and control method 200 for an automobile according to the principles of the present application is illustrated. While the method 200 specifically references the BEV 100 and its components for illustrative/descriptive purposes, it will be appreciated that the method 200 could be applicable to any suitably configured automobile. The method 200 begins at 204 where a training or offline phase for the wind energy estimation model begins. Specifically, at 204, the external computing system 144 determines an aerodynamic characterization of the automobile 100. This step is performed offline, for intended use in a subsequent separate real-time (online) process. In other words, the resulting aerodynamic characterization of the automobile 100 is represented in the real-time application. Traditionally, automobile aerodynamic characterization is done primarily in a frontal configuration. This approach, while not the best or most optimal, is acceptable for some automobiles (e.g., engine-only automobiles) but can lead to significant inaccuracies for BEVs subjected to conditions with tangible wind effects. The proposed technique extracts a 2D aerodynamic characterization of the automobile 100 by computational fluid dynamics (CFD) and/or experimental methods in which data is collected by varying, over the entire automobile operating range, the relative speed and angle of attack of the air stream with respect to the automobile motion.

CFD runs are typically faster and more convenient to execute than experimental methods (e.g., directing air flow towards the automobile in a dynamometer chamber from numerous angles can be awkward), and thus a recommended approach is to calibrate a CFD model against a limited number of experimental (e.g., wind tunnel) data points, and then use the CFD model to calibrate the aerodynamic coefficient over the entire operating range in the road load equation. It also may be possible to collect data from test automobiles instrumented with air flow centers and then driven on city roads or highways. While the aerodynamic coefficient is traditionally considered to be constant, the proposed techniques characterize it as a function of automobile speed, wind speed, and angle of attack. It is well-known that there is a slight difference between the fluid flow problem resolved in a dynamometer chamber as compared with an automobile traveling on an open road. This difference stems from the fact that the floor of the dynamometer chamber is stationary with respect to the automobile, whereas the relative velocity between the ground and a moving automobile is non-zero under normal driving conditions. Hence, the road surface “boundary condition,” and the evolution of the various boundary layers in the domain, are different.

In practice, if the effect of the motion of the automobile with respect to the round can be neglected, and the characterization may be performed as a function of only automobile-air relative speed and angle of attack. Although this characterization may in itself be acceptable, it is also be possible to develop a lumped correction factor for the effect of the ground on the aerodynamic coefficient (optionally related to the automobile-to-road relative speed), rather than to characterize the coefficient with a three-dimensional (3D) table, which may be more expensive to construct and more resource intensive to interpolate in real-time. Corrections for all operating conditions that have been anticipated and discussed above may be developed. For instance, the following factors could contribute to commensurate corrections: (1) air density as a function of ambient temperature and pressure, and (2) scaling of wind speed due to elevation differences in data collection/utilization and due to sheltering by road-side wind barriers (structures, trees, hills/mountains, etc.). In a more sophisticated embodiment, in an attempt to account for reduced drag experienced by groups of automobiles, a correction to the aerodynamic coefficient due to (3) traffic density in the vicinity, including both speed and direction, may be developed.

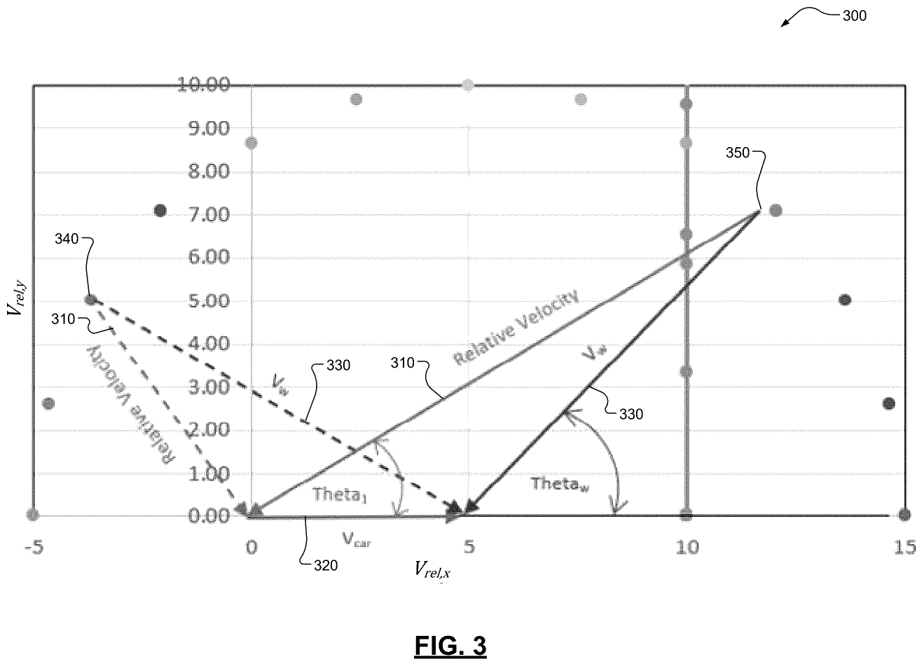

The basic approach for modeling the aerodynamic force of the automobile 100 is to model the force to be proportional to the square of the relative velocity between the automobile 100 and the surrounding airstream, acting in the direction of that relative velocity. The automobile speed, wind speed, and wind angle are used to compute the relative velocity and the aerodynamic drag force. The longitudinal component of that aerodynamic drag force resists the motion of the automobile 100. FIG. 3 illustrates a plot 300 of relative velocity vectors 310 when the automobile speed 320 is ˜5 m/s and the wind speed 330 is ˜10 m/s for two wind angles: θ_{w}=−45° and 150° (points 340 and 350, respectively). Note that, in the latter case, the relative velocity has a component in the positive x-direction, and hence exerts a force on the automobile that aids the motion. Applying the cosine rule to the triangle consisting of the vectors/arrows 310, 320, and 330, the magnitude of the relative velocity (vᵣₑₗ) can be written as:

$$\begin{matrix}{v}_{rel} = \sqrt{{v}_{w}^{2} + {v}_{car}^{2} + 2 {v}_{w} {v}_{car} cos ( 180 ° - {θ}_{w} )} \\ = \sqrt{{v}_{w}^{2} + {v}_{car}^{2} + 2 {v}_{w} {v}_{car} cos ( {θ}_{w} )}\end{matrix} \qquad ( 1 )$$

where v_{w} represents the wind speed or velocity, v_{car} represents the velocity of the automobile 100, and θ_{w} represents the direction of the wind, and:

$${F}_{rel} = {f}_{2 θ} {v}_{rel}^{2} \qquad ( 2 )$$

where f_{2θ} represents the wind angle dependent aerodynamic coefficient (a function of the angle of attack) and Fᵣₑₗ represents the aerodynamic force acting in the direction of the relative velocity vᵣₑₗ. Calculation of the force Fᵣₑₗ itself requires an estimate of f_{2θ} as a function of θ₁. Calibration of the automobile 100 to establish the function f_{2θ} (θ₁) may be carried out by either (i) CFD, (ii) dynamometer (chamber) testing, or (iii) some combination of CFD and dynamometer testing. A more comprehensive calibration estimates f_{2θ} as a function of v_{car}, v_{w}, and θ₁

After obtaining the aerodynamic characterization of the automobile 100 performed offline by the external computing system 144 at 204, the method 200 proceeds to 208 for the real-time (online) portion of the method 200 that is executed by the control system 128. For example, the aerodynamic characterization of the automobile 100 (i.e., a collection of representative data) could be uploaded to the memory 132. At 208, the control system 128 determines the wind speed and wind direction (e.g., from a weather-specific API 148 or other meteorological source). At 212, the control system 128 estimates the relative velocity between the automobile and the surrounding air stream. This relative velocity vᵣₑₗ could be estimated as previously described using above-described Equation (1):

$${v}_{rel} = \sqrt{{v}_{w}^{2} + {v}_{car}^{2} + 2 {v}_{w} {v}_{car} cos ( {θ}_{w} )} \qquad ( 1 )$$

where v_{w} represents the wind speed or velocity, v_{car} represents the velocity of the automobile 100, and θ_{w} represents the direction of the wind. As previously mentioned, the wind speed/direction could be measured or obtained from the external API 148 or another suitable meteorological source. At optional 216, the control system 128 corrects the estimated relative velocity vᵣₑₗ based on at least one of (i) elevation differences in data collection versus data utilization, (ii) sheltering by road-side wind barriers (structures, trees, etc.), (iii) the effect of the ground surface on the aerodynamic coefficient (described above), and/or (iv) automobile traffic density as previously discussed herein. The method 200 then proceeds to 220.

Using the singe rule on the same triangle as shown in FIG. 3 and previously discussed above, an expression is obtained for the angle of attack θ₁ made by the relative velocity vector with the automobile velocity vector, as follows:

$$\frac{sin {θ}_{1}}{{v}_{w}} = \frac{sin ( 180 ° - {θ}_{w} )}{{v}_{rel}} \qquad ( 3 )$$

### Therefore,

$${θ}_{1} = arc sin ( \frac{{v}_{w}}{{v}_{rel}} sin {θ}_{w} ) \qquad ( 4 )$$

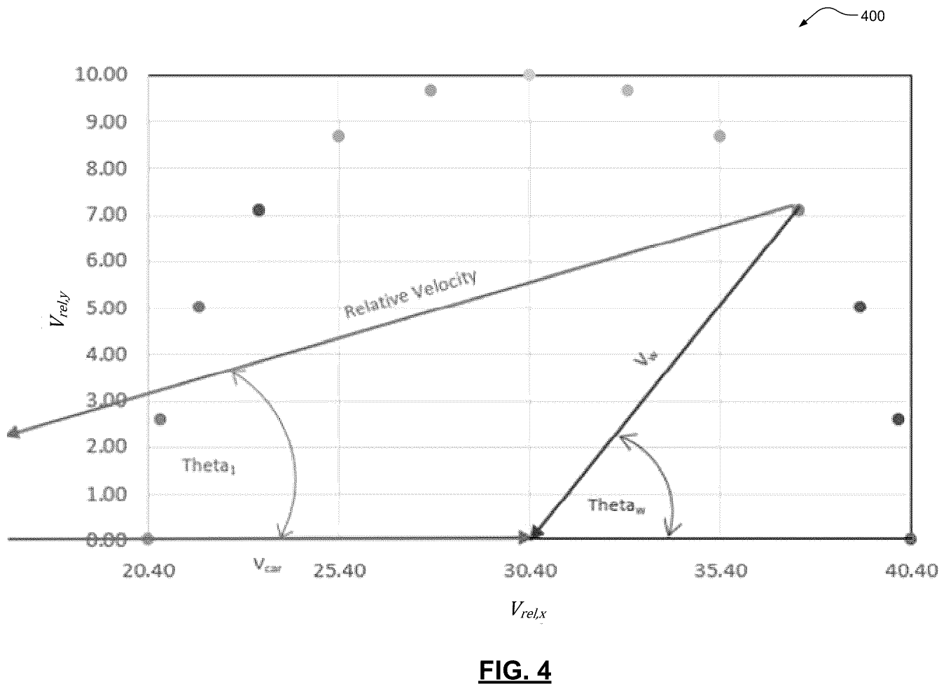

In a real-time algorithm, it is necessary for the algorithm to select the right value of θ₁ if it is multi-valued. The term arcsin(θ₁) can be “bivalued” in the range (0≤θ₁≤180), with one value in the first quadrant and the other in the second quadrant. Thus, care must be taken to select the correct value. To do this, we note from FIG. 3 that θ₁ is zero when θ_{w} is zero. From Equation (3) above, the argument of the arcsine function increases from zero when θ_{w}=0° to some maximum, and back to zero at θ_{w}=180°. When v_{car}>v_{w}, as shown in the plot 400 of FIG. 4, v_{w} is always less than vᵣₑₗ, the argument of the arcsine function is always less than 1, and θ₁ is always less than 90° and hence single valued.

However, when v_{car}<v_{w}, as shown in FIG. 3, v_{w} can be greater than vᵣₑₗ for larger θ_{w} values (see the dashed lines 310 and 330 in FIG. 3), and the argument of the arcsine function undergoes a maximum at some θ_{w} value greater than 90° (corresponding to θ_{w}=120° in FIG. 3). At this point, θ₁ is 90°, i.e. the relative velocity vector is vertical. The value of θ_{w} at this point is denoted by θ_{w,crit}. For θ_{w} values greater than θ_{w,crit}, θ₁ lies in the second quadrant (see FIG. 3). It is instructive to note that θ_{w}=θ_{w,crit} corresponds to a point at which the longitudinal component of wind velocity is identical to the automobile velocity vector. Hence, no longitudinal drag is exerted on the automobile. Thus, under those circumstances, no further calculation is required. It may also be possible, with minimal error, to assume zero drag if θ_{w} lies within a certain proximity with θ_{w,crit} (e.g. ±10°). In summary, when v_{car}>v_{w}, as in FIG. 4, θ₁ always lies in the first quadrant. For v_{car}<v_{w}, when θ_{w}<θ_{w,crit}, θ₁ is in the first quadrant, whereas when θ_{w}>θ_{w,crit}, θ₁ is in the second quadrant. Thus, calculating θ_{w,crit} and comparing its value to θ_{w} allows us to select the appropriate value of θ₁ when it is bivalued.

The aforementioned argument is represented by the equations outlined below.
(v_{car}>v_{w})=>Equation (4) holds (repeated below for convenience):

$${θ}_{1} = arcsin ( \frac{{v}_{w}}{{v}_{rel}} sin {θ}_{w} ) \qquad ( 5 )$$

Considering the triangle in FIG. 3 formed by the three velocity vectors 310-330 when θ_{w}=θ_{w,crit}, (i.e. when θ₁ is 90°), we can write an expression for θ_{w,crit}, as follows:

$$( {v}_{car} < {v}_{w} ) \to {θ}_{w , crit} = 180 ° - arccos ( \frac{{v}_{car}}{{v}_{w}} ) \qquad ( 6 )$$

Also, (v_{car}=v_{w})=>(θ_{w,crit}=180°). Here, θ_{w}=θ_{w,crit} corresponds to a case in which the automobile and wind speed vectors are identical (in both magnitude and direction), i.e., there is no aerodynamic drag on the automobile. Again, under these circumstances, no further calculation is required.

$$( {v}_{car} = {v}_{w} ) \to {θ}_{w , crit} = 180 ° \qquad ( 7 )$$

Considering the arcsine function will always return a value in the first quadrant, we can select the appropriate value of θ₁ for (v_{car}≤v_{w}) by comparing θ_{w} to θ_{w,crit}, as follows:

$$( {v}_{car} \leq {v}_{w} ) and ( {θ}_{w} < {θ}_{w , crit} ) \to {θ}_{1} = arcsin ( \frac{{v}_{w}}{{v}_{rel}} sin {θ}_{w} ) \qquad ( 8 )$$

$$( {v}_{car} < {v}_{w} ) and ( {θ}_{w} > {θ}_{w , crit} ) \to {θ}_{1} = 180 ° - arcsin ( \frac{{v}_{w}}{{v}_{r e l}} sin {θ}_{w} ) \qquad ( 9 )$$

In real-time estimation of the aerodynamic force on the automobile 100 given the automobile speed and the wind speed and angle, Equations (5) through (9) can be used to calculate θ₁, the at which the force acts.

The aerodynamic force in the direction of the relative velocity vector can be computed from Equation (2). The longitudinal component of this force (which is zero for θ_{w}=θ_{w,crit}) that resists the forward motion of the automobile is the given by:

$$( {θ}_{w} = {θ}_{w , crit} ) \to ( {θ}_{1} = 90 ° ) and ( {F}_{rel , longitudinal} = 0 ) \qquad ( 10 )$$

$${F}_{r el , longitudinal} = {f}_{2 θ} {v}_{rel}^{2} cos {θ}_{1} \qquad ( 11 )$$

In some instances, the real-time algorithm that incorporates this wind model calculates aerodynamic drag by multiplying the frontal f₂ coefficient with the square of the automobile speed rather than the square of the relative velocity (as in Equation (11)). Therefore, the f₂ value in the algorithm must be scaled to reflect the correct velocity, as follows:

$${f}_{2 θ , scaled} = \frac{{f}_{2} {v}_{rel}^{2} cos {θ}_{1}}{{v}_{car}^{2}} \qquad ( 12 )$$

The corrected coefficient may be used along with the traditional road load equation as follows:

$$F = {f}_{0} + {f}_{1} * {v}_{car} + {f}_{2 θ , scaled} * {v}_{car}^{2} . \qquad ( 13 )$$

Returning to the flow diagram of method 200 in FIG. 2, at 220, the control system 128 estimates the angle of attack θ₁ of the air stream by estimating the direction of the relative velocity vector between the automobile and the surrounding air. This estimation could be calculated, for example, using the above-described Equations (5)-(9). At 224, the control system 128 determines the longitudinal component (F_{rel,longitudinal}) of the aerodynamic force (Fᵣₑₗ) acting on the automobile 100 in the presence of wind-affected conditions. In one example implementation, the longitudinal component F_{rel,longitudinal} is determined using above-described Equations (10)-(12). At optional 228, the longitudinal component F_{rel,longitudinal} is optionally modified or adjusted based on an updated air density as a function of ambient temperature and pressure. Finally, at 232, the control system 128 introduces the longitudinal component F_{rel,longitudinal} of the aerodynamic force Fᵣₑₗ into an automobile energy or power budget, such as the road load equation. In one example implementation, this introduction is via above-described Equations (12)-(13).

In one exemplary implementation, the control system 128 takes the longitudinal component of the aerodynamic force into account as part of an automobile energy consumption estimation, which could be performed using a previously-trained (offline) physics-based energy consumption model. This energy consumption model could leverage the more accurate estimation of the impact of the wind energy via this longitudinal force component to obtain a more accurate estimation of automobile energy consumption accounting for wind energy. This could result in, for example, a more accurate estimation of a current or remaining range of the automobile 100. For BEV applications, this range estimation is crucial to the customer's experience and even a few additional miles of range could drastically impact the experience. In particular, during long BEV trips, precise planning must occur to determine where/when to recharge the BEV. By more accurately estimating the BEV's range based on this more accurate estimation of the impact of wind energy on the BEV, the trip planning process could be further optimized, thereby saving the customer time/money and improving their overall experience.

It will be appreciated that the terms “controller” and “control system” as used herein refer to any suitable control device or set of multiple control devices that is/are configured to perform at least a portion of the techniques of the present application. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. A wind energy estimation and control system for an automobile, the wind energy estimation and control system comprising:
a memory configured to store data indicative of an aerodynamic characterization of the automobile, the data indicative of the aerodynamic characterization of the automobile having been generated offline by an external computing system; and
a control system configured to access the memory and to:
determine a speed and direction of a wind impacting the automobile;
estimate a relative velocity between the automobile and a surrounding airstream based on the data indicative of the aerodynamic characterization, the wind speed, and the wind direction;
estimate an angle of attack of the airstream based on the estimated relative velocity between the automobile and the surrounding airstream;
estimate a longitudinal component of an aerodynamic drag force impacting the automobile based on the estimated angle of attack of the airstream, the wind speed, and the wind direction; and
generate an output based on the estimated longitudinal component of the aerodynamic drag force impacting the automobile.

2. The wind energy estimation and control system of claim 1, wherein the control system is further configured to access a trained energy consumption model stored in the memory and use the trained energy consumption model and the estimated longitudinal component of the aerodynamic drag force impacting the automobile to generate an estimated energy consumption of the automobile.

3. The wind energy estimation and control system of claim 2, wherein the generated output is an estimated range of the automobile.

4. The wind energy estimation and control system of claim 1, wherein the aerodynamic characterization of the automobile is a model of an aerodynamic force of the automobile that is proportional to a square of the relative velocity between the automobile and the surrounding airstream acting in the direction of the relative velocity.

5. The wind energy estimation and control system of claim 4, wherein the control system is configured to estimate the relative velocity (vᵣₑₗ) between the automobile and the surrounding airstream as follows:
$${v}_{rel} = \sqrt{{v}_{w}^{2} + {v}_{car}^{2} + 2 {v}_{w} {v}_{car} cos ( {θ}_{w} )}$$
where v_{w} represents the wind speed, v_{car} represents a speed of the automobile, and θ_{w} represents the wind direction.

6. The wind energy estimation and control system of claim 5, wherein the control system is further configured to correct the estimated relative velocity vᵣₑₗ based on at least one of (i) elevation differences in data collection versus data utilization, (ii) sheltering by road-side wind barriers, (iii) an effect of the ground surface on the aerodynamic coefficient, and/or (iv) automobile traffic density.

7. The wind energy estimation and control system of claim 5, wherein the control system is configured to estimate the angle of attack using the following equations:
$${θ}_{1} = arcsin ( \frac{{v}_{w}}{{v}_{rel}} sin {θ}_{w} ) \\ ( {v}_{car} < {v}_{w} ) \to {θ}_{w , crit} = 180 ° - arccos ( \frac{{v}_{car}}{{v}_{w}} ) \\ ( {v}_{car} = {v}_{w} ) \to {θ}_{w , crit} = 180 ° \\ ( {v}_{car} \leq {v}_{w} ) and ( {θ}_{w} < {θ}_{w , crit} ) \to {θ}_{1} = arcsin ( \frac{{v}_{w}}{{v}_{rel}} sin {θ}_{w} ) \\ ( {v}_{car} < {v}_{w} ) and ( {θ}_{w} > {θ}_{w , crit} ) \to {θ}_{1} = 180 ° - arcsin ( \frac{{v}_{w}}{{v}_{r e l}} sin {θ}_{w} ) ,$$
where θ₁ represents the angle of attack, ranging from 0° to a critical angle θ_{w,crit}, v_{w} represents the wind speed, θ_{w} represents the wind direction, and v_{car} represents the automobile speed.

8. The wind energy estimation and control system of claim 7, wherein the control system is configured to estimate the longitudinal component (F_{rel,longitudinal}) of the aerodynamic drag force (Fᵣₑₗ) impacting the automobile using the following equations:
$${F}_{rel , longitudinal} = {f}_{2 θ} {v}_{rel}^{2} cos {θ}_{1} \\ {f}_{2 θ , scaled} = \frac{{f}_{2} {v}_{rel}^{2} cos {θ}_{1}}{{v}_{car}^{2}} ,$$
where f_{2θ,scaled} represents a scaled version of a frontal coefficient f₂ from a road load equation:
$${F}_{rel} = {f}_{0} + {f}_{1} * {v}_{car} + {f}_{2 θ , scaled} * {v}_{car}^{2} ,$$
where f₀ and f₁ represent a constant and another coefficient In the road load equation.

9. The wind energy estimation and control system of claim 1, wherein the automobile is a battery electric vehicle (BEV) that does not include an internal combustion engine.

10. The wind energy estimation and control system of claim 1, wherein the control system is configured to receive the wind speed and wind direction from a weather application program interface (API).

11. A wind energy estimation and control method for an automobile, the wind energy estimation and control method comprising:
receiving and storing, by a memory and from an external computing system, data indicative of an aerodynamic characterization of the automobile, the data indicative of the aerodynamic characterization of the automobile having been generated offline by the external computing system;
determining, by a control system of the automobile that is configured to access the memory, a speed and direction of a wind impacting the automobile;
estimating, by the control system, a relative velocity between the automobile and a surrounding airstream based on the data indicative of the aerodynamic characterization, the wind speed, and the wind direction;
estimating, by the control system, an angle of attack of the airstream based on the estimated relative velocity between the automobile and the surrounding airstream;
estimating, by the control system, a longitudinal component of an aerodynamic drag force impacting the automobile based on the estimated angle of attack of the airstream, the wind speed, and the wind direction; and
generating, by the control system, an output based on the estimated longitudinal component of the aerodynamic drag force impacting the automobile.

12. The wind energy estimation and control method of claim 11, further comprising accessing, by the control system and from the memory, a trained energy consumption model stored in the memory and using, by the control system, the trained energy consumption model and the estimated longitudinal component of the aerodynamic drag force impacting the automobile to generate an estimated energy consumption of the automobile.

13. The wind energy estimation and control method of claim 12, wherein the generated output is an estimated range of the automobile.

14. The wind energy estimation and control method of claim 11, wherein the aerodynamic characterization of the automobile is a model of an aerodynamic force of the automobile that is proportional to a square of the relative velocity between the automobile and the surrounding airstream acting in the direction of the relative velocity.

15. The wind energy estimation and control method of claim 14, wherein the estimating of the relative velocity (vᵣₑₗ) between the automobile and the surrounding airstream is performed as follows:
$${v}_{rel} = \sqrt{{v}_{w}^{2} + {v}_{car}^{2} + 2 {v}_{w} {v}_{car} cos ( {θ}_{w} )}$$
where v_{w} represents the wind speed, v_{car} represents a speed of the automobile, and θ_{w} represents the wind direction.

16. The wind energy estimation and control method of claim 15, further comprising correcting, by the control system, the estimated relative velocity vᵣₑₗ based on at least one of (i) elevation differences in data collection versus data utilization, (ii) sheltering by road-side wind barriers, (iii) an effect of the ground surface on the aerodynamic coefficient, and/or (iv) automobile traffic density.

17. The wind energy estimation and control method of claim 15, wherein the estimating of the angle of attack is performed using the following equations:
$${θ}_{1} = arcsin ( \frac{{v}_{w}}{{v}_{r e l}} sin {θ}_{w} ) \\ ( {v}_{car} < {v}_{w} ) \to {θ}_{w , crit} = 180 ° - arccos ( \frac{{v}_{car}}{{v}_{w}} ) \\ ( {v}_{car} = {v}_{w} ) \to {θ}_{w , crit} = 180 ° \\ ( {v}_{car} \leq {v}_{w} ) and ( {θ}_{w} < {θ}_{w , crit} ) \to {θ}_{1} = ( \frac{{v}_{w}}{{v}_{rel}} sin {θ}_{w} ) \\ ( {v}_{car} < {v}_{w} ) and ( {θ}_{w} > {θ}_{w , crit} ) \to {θ}_{1} = 180 ° - ( \frac{{v}_{w}}{{v}_{rel}} sin {θ}_{w} ) ,$$
where θ₁ represents the angle of attack, ranging from 0° to a critical angle θ_{w,crit}, v_{w} represents the wind speed, θ_{w} represents the wind direction, and v_{car} represents the automobile speed.

18. The wind energy estimation and control method of claim 17, wherein the estimating of the longitudinal component (F_{rel,longitudinal}) of the aerodynamic drag force (Fᵣₑₗ) impacting the automobile is performed using the following equations:
$${F}_{rel , longitudinal} = {f}_{2 θ} {v}_{rel}^{2} cos {θ}_{1} \\ {f}_{2 θ , scaled} = \frac{{f}_{2} {v}_{rel}^{2} cos {θ}_{1}}{{v}_{car}^{2}} ,$$
where f_{2θ,scaled} represents a scaled version of a frontal coefficient f₂ from a road load equation:
$${F}_{rel} = {f}_{0} + {f}_{1} * {v}_{car} + {f}_{2 θ , scaled} * {v}_{car}^{2} ,$$
where f₀ and f₁ represent a constant and another coefficient In the road load equation.

19. The wind energy estimation and control method of claim 11, wherein the automobile is a battery electric vehicle (BEV) that does not include an internal combustion engine.

20. The wind energy estimation and control method of claim 11, wherein the determining of the wind speed and wind direction comprises receiving, by the control system and from a weather application program interface (API), the wind speed and wind direction.
